(19) United States
(12) Patent Application Publication
(10) Pub. No.: US 2008/0115576 A1
(43) Pub. Date: May 22, 2008

(54) Flexible Multifunctional Valve

(75) Inventor: Leif Marstorp, Ljung (SE)

Correspondence Address: DAVIS BUJOLD & Daniels, P.L.L.C., 112 PLEASANT STREET, CONCORD, NH, 03301, US

(73) Assignee: Tour & Andersson AB, Ljung (SE)

(21) Appl. No.: 11/817,990

(22) PCT Filed: Feb. 13, 2006
(86) PCT No.: PCT/SE06/00187

§ 371 Date: Sep. 7, 2007

(30) Foreign Application Priority Data
Mar. 10, 2005 (SE) 0500537-6

(51) Int. Cl. G01F 15/00

(52) U.S. Cl. 73/199

(57) ABSTRACT

A device for a flow regulation and a measurement of a medium in a heating or cooling system, which device comprises a multifunctional valve, which comprises a collector (1) with measuring outlets and an adapter for discharge and which is mounted jointly with a flow control part (2), the one part being rotatable in relation to the other part but locked in an axial direction.

This is a national stage completion of PCT/SE2006/000187 filed Feb. 13, 2006 which claims priority from Swedish Application Serial No. 0500537-6 filed Mar. 10, 2005.

### FIELD OF THE INVENTION

The present invention relates to a flow regulation valve with a rotatable positioning of measuring outlets in relation to the flow regulating function, and in a design, which meets the requirements of the market place.

### BACKGROUND OF THE INVENTION

Modern constructions of valves, which as to certain functions are similar to the design described in the following text, have a few drawbacks, which now can be eliminated by the present invention.

Thus, U.S. Pat. No. 5,533,549 relates to a valve with an integrated, replaceable venturi part, which is mounted in the same valve body as the measuring outlets, which belong to the venturi, and in the same valve body as the flow-limiting ball valve, which also belongs to it. This means, that the position of the measuring outlets always is the same in relation to the ball valve.

Another valve construction, with the same functional build-up as the one described in U.S. Pat. No. 5,533,549, is described in WO 01/71289 A1. The similarity between the US patent and this patent application is the same in principle, since the two constructions are based on a valve body, which contains the two measuring outlets and the flow regulating function. Thus, also in the later case all the adapters are locked in their position in relation to each other

In the market place solutions have been developed, which have comprised two valve bodies, one of which has comprised the regulation function and the other one has comprised the measuring function, i.e. a venturi part plus a measuring outlet. These parts have subsequently been screwed together with an internal and external thread. The problem with this type of solution is, that the measuring outlets not always will end up in the same position in relation to the ball valve or the handle/lever of the regulation part, but this position will be determined by the position of the threaded inlets in the two valve bodies. Also, in a mounted position the relative position of the measuring outlets and the handle/lever of the flow regulation function is locked.

The drawbacks of the constructions described above are several. The most important one of them is, that no such construction results in a flexibility, as regards the positions of the measuring outlets in relation to the regulation function.

The market place requirements have been clearly stated: An as large as possible freedom of choice is aimed at, as regards the mounting position of this type of valves, without forgoing the accessibility during service or adjustment work. Also, there are other requirements regarding the functions, which are not met by the modern constructions.

### SUMMARY OF THE INVENTION

The object of the present invention is to counteract and as far as possible remove the above-mentioned drawbacks. Also, one object of the invention is to develop the art in this technical field, within other application areas as well as for other applications of valves, which are not specifically mentioned in the present patent application.

These objects are attained by constructing a multifunctional valve in such a way, as is defined herein.

### BRIEF DESCRIPTION OF THE DRAWINGS

Additional characterizing features and advantages of the present invention are set forth in the following description, reference being made to the enclosed drawings, which show a few not limiting embodiments.

The drawings show in detail in:

FIG. 1 an external front view of the valve;

FIG. 1A an external left side view of the valve;

FIG. 1B an external top view of the valve;

FIG. 2 a sectional view;

FIG. 3 a detailed view of FIG. 2;

FIG. 4 an additional detailed view of FIG. 2;

FIG. 5 a sectional view of an alternative embodiment; and

FIG. 6 a detailed view of FIG. 5.

### DETAILED DESCRIPTION OF THE INVENTION

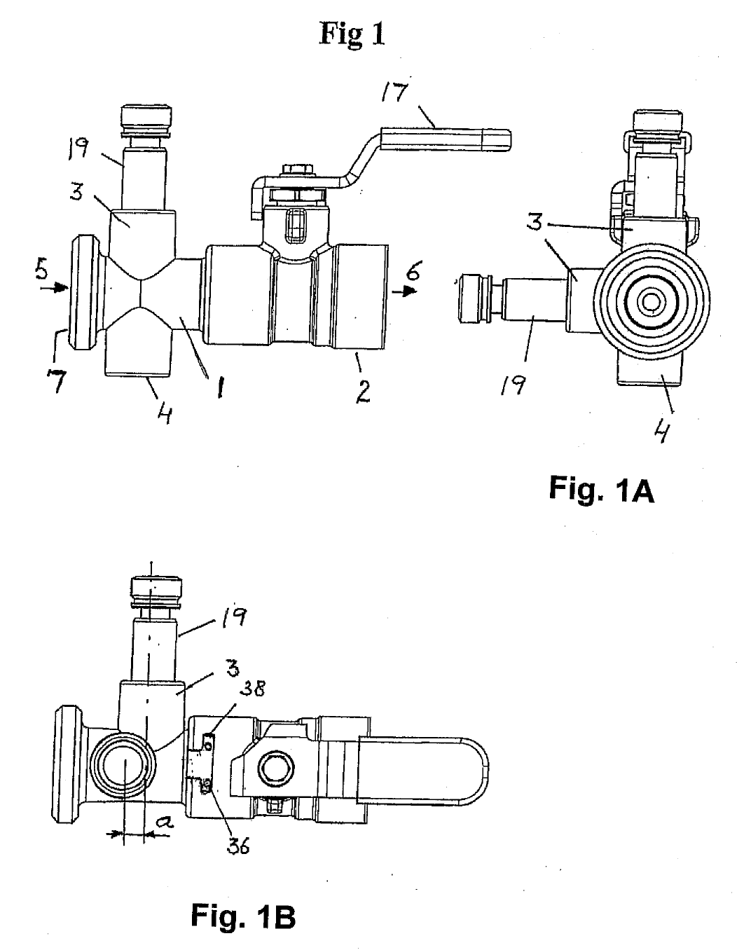

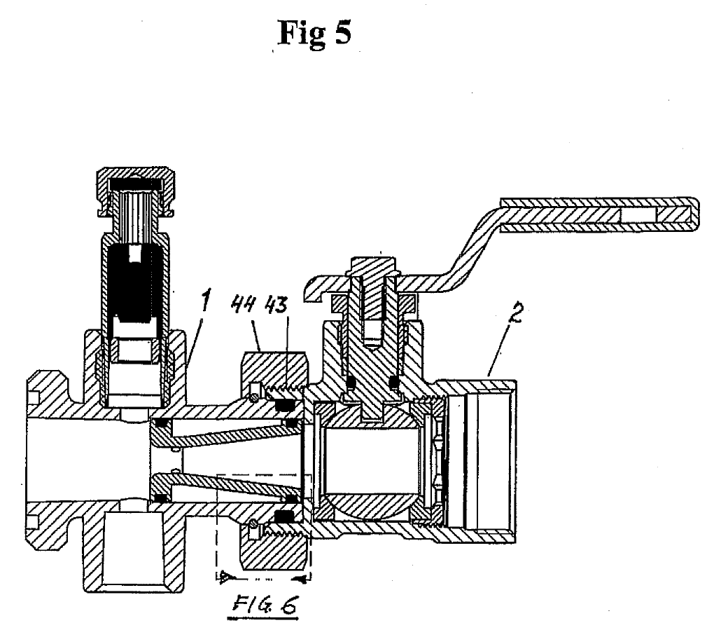

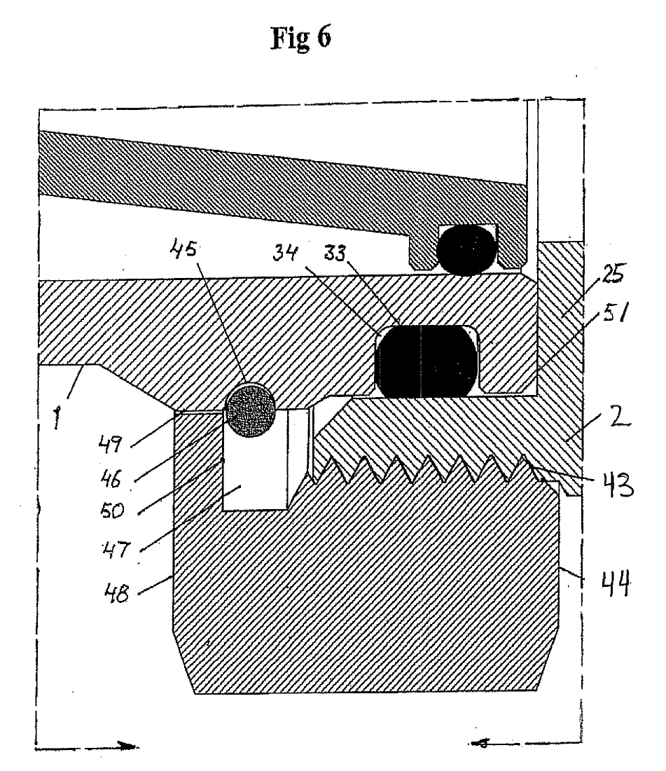

FIGS. 1, 1A, 1B show only one example of how a valve according to the present invention may look. Of course, embodiments according to the present invention may differ from the embodiment shown in FIGS. 1, 1A, 1B, while achieving the same function as the embodiment, described in the present text. Examples of this function are shown in FIGS. 5 and 6.

Thus, FIGS. 1, 1A, 1B show external views of a complete multifunctional valve array, in which a collector 1 is rotatably connected to a flow control part 2, forming a unit. The multifunctional valve is provided with an inlet 5 and an outlet 6.

It is shown in the drawings, that the collector 1 is provided with several lateral adapters. There are two adapters 3 having mounted nipples 19, which are disposed on the periphery of the collector and are normally at somewhat different distances from the adapter plane 7 of collector 1 and are preferably at a 90° angle with respect to the outlets. In the same plane as measuring outlet 3, which is disposed very close to adapter plane 7 of collector 1, there is also an adapter for a discharge 4, which preferably is disposed at a 180° angle with respect to the last-mentioned measuring outlet. There is an axial distance=a between the two measuring outlets, which is determined by the design of venturi part 8, which is mounted in collector 1. Collector 1 can of course be provided with an additional adapter, not just adapters 3 and 4, e.g. for ventilation, and this adapter may be disposed in almost the same axial plane as the adapter for discharge.

These figures also show a lever 17, by means of which a closing device 14 of a flow control part 2 is controlled, and a recess 38, in which a locking ring 36, for locking the collector 1 to the flow control part 2, has its ends, and is accessible from the outside.

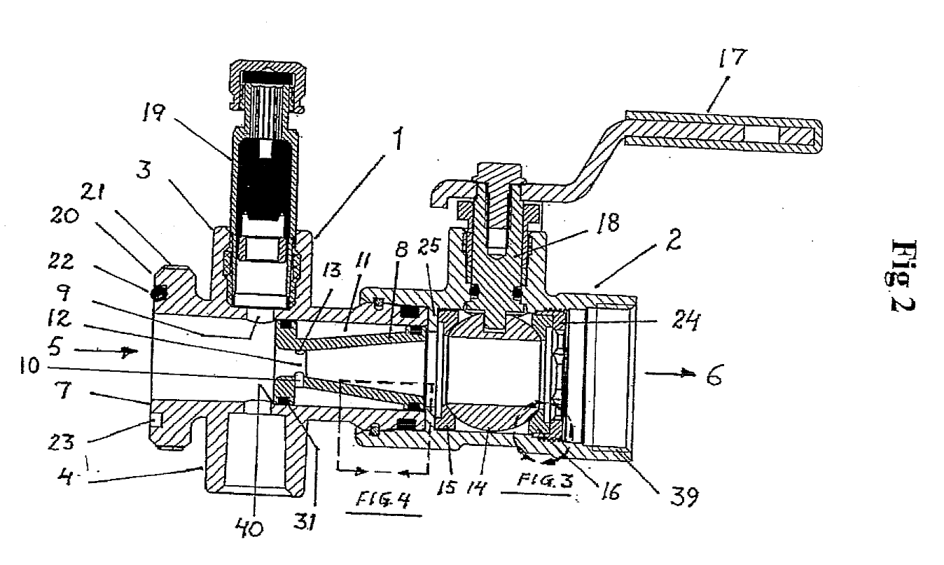

FIG. 2 shows a sectional view through the complete unit.

The flow path through the unit extends from the inlet 5 to the outlet 6. The inlet has an adapter 20 with an outer thread 21 for connection and mounting the unit in a tube system or the like, the thread 21 being adjusted to a standardized overflow nut or a similar attachment part. The attachment part is sealed against the collector 1 by an O-ring 22, which is fitted into a machined O-ring groove 23. FIG. 2 also shows adaptors 3 for retaining measuring nipples 19 and an adapter 4 for discharge, respectively. Measuring nipples 19 are described in earlier patent documents, e.g. in SE 465 636. In order to obtain a measuring signal to the two measuring nipples 19, a drilled hole 9 is used, in contact with a first zone in collector 1 and is disposed immediately in front of venturi part 8, and which directs a static pressure, from this zone up to the measuring outlet. The second measuring outlet, which is disposed further away from the adapter plane 7, obtains its pressure signal via a corresponding hole 10, which runs into space 11, which in turn contacts an inlet zone 12 of the venturi part 8, in which a few—preferably 4—holes 13 forward the pressure, present in this zone out into the measuring outlet. In order to obtain the right pressure level and consequently also the right pressure signal in space 11, the venturi part 8 is provided with O-rings 31 and 32 in the two end portions.

The venturi part maybe a separate element, mounted in the collector or maybe is an internally machined part in the collector 1, and designed in such a way, that the venturi function is obtained. In this case, a hole 10 is drilled directly into the zone of the venturi part, corresponding to the place, where holes 13 are disposed according to FIG. 2.

The venturi part 8 comprises various geometries, which are adapted partly to the various sizes and various inner diameters as well as partly to various volume streams within one and the same dimension of the collector, in which consequently various requirements as to the venturi part and its measuring areas can be met. This means, that it must be possible to mount various venturi parts according to current customer requirements. The venturi part is mounted in collector 1, before the latter is connected to venturi part 2. During mounting the venturi part is pressed into the collector, and its rear part, and to such an extent, that the front part of the venturi part is stopped by collar 40, which is present in the collector. Thus, the collector has a somewhat larger—preferably about 1 mm—diameter in the section, in which the venturi part is to be placed. When collector 1 has been united with the valve part 2, the venturi part will be held in place also in its rear part, since the wall 25 limits it in this direction.

The flow control part 2 has an outlet end 6 with an internal thread 39. A closing device 14, preferably a ball, is mounted in the flow control part 2. A sealing element 15 is positioned on the inner side of ball 14, when seen from outlet 6, and is limited by its outer end of wall 25, which is present within the flow control part.

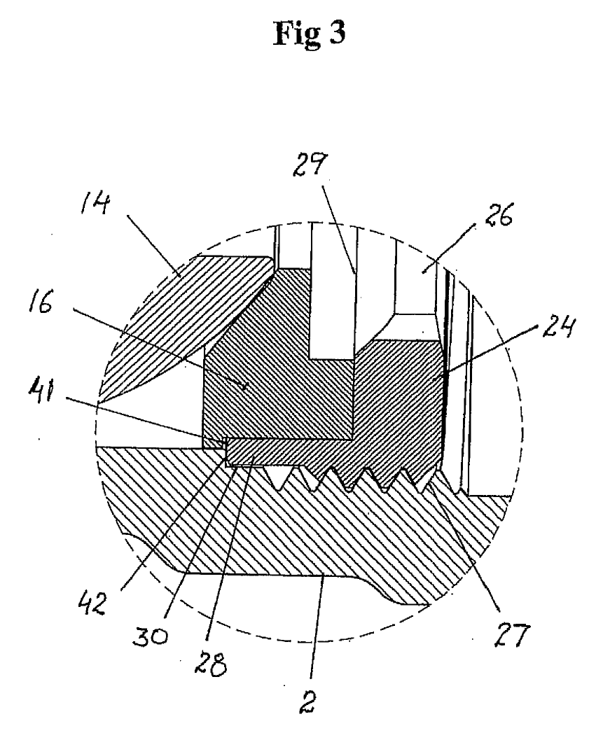

FIG. 3 shows, how a second sealing element 16 is pressed against the ball 14 by a locking ring 24, which is mounted on thread 27 by a socket head key, via a socket head recess 26. In order to guarantee, that locking ring 24 is mounted in its right axial position, the locking ring is provided with an outer ring portion 28 in its front end. This ring portion 28 has a thickness of about 0.2-1.5. The dimensions are chosen to let the ring be guided externally by means of a turned groove 30, which is machined up to flow control part 2, its inner diameter in the front portion of the ring portion at the same time being communicating with the sealing element 16 at its outer diameter. In this correct axial mounting position metallic contact between the ring portion 28 and its front end face 41 is obtained, which extends towards collar 42, which is retained, where the turned groove 30 ends. In this mounting position correct forces have been applied against sealing elements 15 and 16 and the tightness and the fixing of closing device 14 have been secured.

The construction with a separate locking ring 24 results in a degree of freedom, as far as the finished mounting of the multifunctional valve in an installation is concerned.

In modern constructions, often a combination of adapter portions are used, which are mounted in the thread 39—FIG. 2. The adapter portions are then designed in such a way, that they partly are sealings 15 and 16 pressing against the closing device 14 and simultaneously function as an adapter portion for the tube system.

By means of the construction now described the installation contractor will be able to select the type of adapter principle/adapter portion, which is suitable, precisely in the present case, e.g. a tube directly threaded to the valve, a tube connection for steal tubes or a connection for soldering.

In FIG. 2 it is shown, that the closing device/ball is turned into the suitable closing or adjustment position by means of a lever 17, which via a top piece 18 transmits the torsional moment for closing the device/ball 14.

This portion of the construction is to be designed in a known, normal way and is not described in detail in this specification.

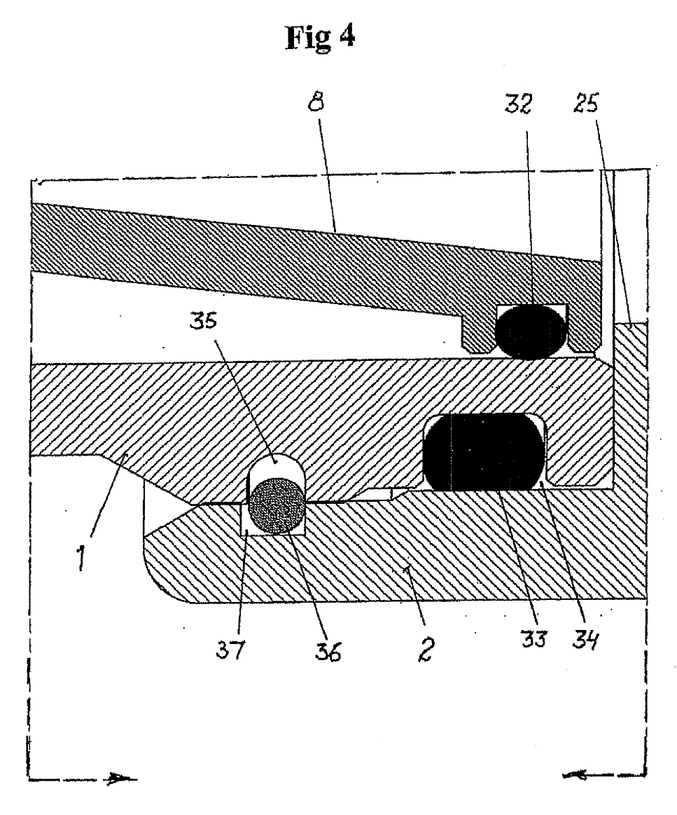

In FIG. 4 it is shown, how the two main components 1 and 2 are mounted and joined into one unit.

FIG. 4 shows, that the collector 1, in its end portion, which faces the flow control part 2, is designed in such a way, that its outer diameter can be mounted into the end of the flow control part, which faces the collector. The collector 1 is provided at this end with externally machined grooves 34, adapted to an O-ring 33 and also a machining—a groove 35—in which a resilient, open locking ring 36 is mounted.

Flow control part 2 also has a machining 37, which is internally positioned and positioned in such a way, that this groove 37 will lie in the middle of groove 35 in the collector, when parts 1 and 2 are jointly mounted.

In order to be able to jointly mount parts 1 and 2, first one part is to be fitted into the other, the collector then being able to enter the flow control part. When part 1 has been introduced such a long way, that the locking ring 36 abuts part 2 and its end face, it is possible, with a mounting tool, to press locking ring 36 inwards in a radial direction in order to make it more or less abut groove 35 and its internal surface. When locking ring 36 lies in this pressed-in position, it is possible to bias the collector 1 further into the part 2, and in this way the locking ring 36 will tend to expand outwards, and when it has arrived into a position, where part 2 and its groove 37 are positioned opposite locking ring 36, the locking ring will spring outwards and lock the two parts 1 and 2 in a radial direction.

In principle, the outer groove 37 may be designed in such a way, that it is possible to remove the locking ring, and in this way, when e.g. servicing is carried out, enabling the replacement any of parts 1 and 2. One solution for being able to do this is, that on about 30-45° of the periphery of part 2 there is a machining, e.g. a cutter grinding, carried out, which means, that a recess 38 is formed and extends all the way up to groove 37—see also FIG. 1B. In this circular segment it is also possible, in this case, to manufacture the locking ring 26 and its end parts in such a way, that it is possible with a special tool to compress the locking ring and its diameter in such a way, that it is exposed in relation to groove 37.

When the two parts 1 and 2 are united as a unit, it is always possible to rotate the two parts in relation to each other. This possibility gives the construction a degree of freedom, which no valve with the corresponding or similar functions has been able to offer so far.

Alternatives of the solution, which are available on known constructions, are based on the possibility of joining the two parts 1 and 2 using expensive threaded joints, which partly are costly and require a lot of space and which also result in a certain leakage risk.

Thus, according to the present invention, flexibility is obtained with a simple locking ring, and at the same time a seal against an outer leakage is guaranteed through O-ring 33, which has been found to be a reliable sealing element, provided the geometrical relationships between the O-ring and the groove, in which it is mounted, have been chosen in the correct way.

The inventive construction, which has been described and shown in FIGS. 1-4, can of course be modified within the scope of the present invention. Thus, the flow control part can e.g. be provided with a mushroom valve as the closing device, and the measuring nipples and the venturi part can also be changed as to their part design, but the main function will nevertheless remain the same.

FIG. 5 shows an alternative design, with regard to how the two main components 1 and 2 are mounted and joined to each other into a unit.

In this case, the flow control part 2 has been provided with an external thread 43 in the end, which meets collector 1, in order to, by means of an overflow nut 44, jointly mount the two parts 1 and 2.

FIG. 6 shows, that the collector 1, at the end that faces the flow control part 2, is designed in such a way, that its outer diameter is introduced into the flow control part. The sealing function is secured in this design in the same way, as has already been described, by means of the O-ring 33, which is mounted in an O-ring groove 34. In collector 1, a groove 45 is made, in which a locking ring 46 is mounted. The groove 45 has the same diameter as the locking ring, and a depth, which is roughly the same as the locking ring radius. The overflow nut 44 has a machined groove 47, which is positioned about 3 mm from the end face 48 of the nut and has a depth of about 5 mm and a width, which is about 1 mm larger than the diameter of locking ring 46.

Mounting of the overflow nut is done such that it firstly is introduced onto the end of the collector and up to adapters 3 and 4, the locking ring then being mounted on top of the collector and is forced upwards onto cylindrical part 49, where groove 45 is positioned. When the locking ring reaches the groove 45, the locking ring snaps into the groove. In the next step an O-ring 33 is mounted.

The collector 1 can now be introduced into the flow control part and the nut 44 can now be moved up to thread 43 in the flow control part and the two parts 1 and 2 can be united by means of threads. When the nut 44 with the groove 47 and its rear edge 50 reach the locking ring, the locking ring and the collector are pressed against the flow control part, the front part 51 of the collector finally being stopped by wall 25 in the flow control part.

Also, with this design it is always possible to rotate the two parts 1 and 2 in relation to each other in order to offer the technician/the installation the flexibility, which is required in order to, in a particular case, be able to place e.g. measuring nipples 19 and adapter 4 for discharge and lever 17 for the flow control part respectively in the suitable positions. The rotation of parts 1 and 2 can be done by loosening the overflow nut 44. When the rotation has been carried out, a suitable tightening moment can be applied again.

### ELEMENT LIST

1=collector (header)
2=flow control part
3=adapter for a measuring nipple
4=adapter for a discharge
5=inlet
6=outlet
7=adapter plane
8=venturi part
9=hole
10=hole
11=space between 8 and 1
12=inlet zone
13=hole
14=closing device
15=sealing element
16=sealing element
17=lever
18=top piece
19=measuring nipple
20=adapter
21=thread
22=O-ring
23=O-ring
24=locking ring
25=wall
26=socket head cup (screw)
27=thread
28=ring portion (part)
29=inner wall
30=groove
31=O-ring
32=O-ring
33=O-ring
34=groove
35=groove
36=locking ring
37=groove
38=recess (cut)
39=thread
40=collar (shoulder)
41=end face
42=diameter reduction
43=thread
44=overflow nut
45=groove
46=locking ring
47=groove
48=end face
49=cylindrical portion
50=rear edge

1-6. (canceled)

7. A device for a flow regulation and a measuring of a medium in a heating or cooling system, the device comprising a multifunctional valve, which comprises two main components, one part comprising a collector (1) with measuring outlets (3) and measuring nipples (19) to match and outlets (4) for a discharge function and one of a mounted venture part and a venturi part (8), integrated into one of the collector and a venturi function and a flow control part (2), comprising a flow-limiting part (14), which is sealed and controlled by sealing elements (15, 16), a locking ring (24) securing tightness and flow limitation being one of adjusted and stopped, to the desirable percentage opening, by a rotatable lever (17), and the collector (1) and the flow control part (2) being mounted jointly into one unit by pushing the collector (1) to one of combine the flow control part (2) to the collector (1) and the flow control part (2) in an axial direction with a locking ring (36) and in an alternative way fix the collector (1) and the flow control part (2) subsequent to combining them by threading an overflow nut (44) into the flow control valve (2) and then via the locking ring (46) locking the collector (1) and the flow control part (2) in the axial direction, the collector (1) is locked in the axial direction and is completely rotatable 360° around a longitudinal axis in relation to the flow control part (2).

8. The device according to claim 7, wherein the collector (1) and the flow control part (2) are disconnected by compressing the locking ring (36), with a special tool, in a radial direction, the meshing of the locking ring (36) in the groove (37) ceasing, such that the collector (1) and the flow control part (2) are separable.

9. The device according to claim 7, wherein the venturi part (8) is replaceable with a venturi part (8) of a different size before the collector (1) and the flow control part (2) are united.

10. The device according to claim 7, wherein the sealing elements (15, 16) are biased in an axial direction against a closing device (14) by a locking ring (24), having an outer annular part (28), which in a final, appropriate mounting position results in metallic contact between a front end face (41) of the annular part and a turned (in a lathe) groove (30) and a collar during a diameter alteration and reduction (42).

11. The device according to claim 7, wherein the outlets (3) for the measuring nipples are positioned with a 90° split, their axial distance (a) being determined by the venturi part (8).

12. The device according to claim 11, wherein the collector (1) is provided with adapters for discharge (4) and deaeration, on a periphery, and for the measuring nipples (3), which may be positioned in a same axial plane as the adapter for the measuring nipple, close to the adapter plane (7) and with 180° separation in relation to the adapter for the measuring outlet.

13. A multifunctional valve device for regulating flow of a medium through at least one of one of a heating system and a cooling system, the valve device comprising:
a collector (1) having at least one adaptor (3) and at least one outlet (4) housing a venturi unit (8), each of the at least one adaptors (3) coupling a measuring nipple (19) to the collector (1) and the at least one outlet (4) enabling discharge of the medium from the collector (1), the venturi unit (8) being housed within the collector unit (1) to effect the flow of the medium through the collector unit (1);
a flow control valve (2) comprising
a flow-limiting valve (14) having a through aperture, the flow-limiting valve (14) is sealed by sealing elements (15, 16) to one of limit and prevent the flow of the medium through the flow control valve (14) and the aperture depending on an orientation of the flow-limiting valve;
a rotatable lever (17) communicating with the flow-limiting valve (14) to adjust the orientation the flow control valve (14) and the aperture;
a locking ring (24) adjustably communicating with an interior of the flow control valve (2) to secure one of the sealing elements (15, 16) against the flow-limiting valve (14) to adjust a rotatability of the flow-limiting valve (14); and
a locking ring (36) axially fixing the collector (1) and the flow control valve (2) together while enabling rotational communication between the collector (1) and the flow control part (2).
